(19) United States
(12) Patent Application Publication
(10) Pub. No.: US 2006/0184436 A1
(43) Pub. Date: Aug. 17, 2006

(54) Method and system for providing a marketplace to professionals

(75) Inventor: Mostafa Edalat Khah, Dubai (AE)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Diagram Standard, a corporation of the United Arab Emirates, Dubai (AE)

(21) Appl. No.: 11/055,932

(22) Filed: Feb. 11, 2005

(51) Int. Cl. G06Q 40/00

(52) U.S. Cl. 705/35

(57) ABSTRACT

A system for providing contact between a buyer and a seller, the system including a first zone in the form of a chat room, the first zone being displayed at the station of the seller and the buyer; a second zone in the form of a data acquisition zone for providing a request associated with the selection of an action and a set of characteristics of a product, the second zone being displayed at the station of the seller and the buyer; a first clickable zone for transforming the request in the data acquisition zone into at least one line in the first zone, the first clickable zone being displayed at the station of the seller and the buyer; a second clickable zone such that, when the second clickable zone is activated, the request is sent to a server which has the ability to compare requests associated with offers and demands, the second clickable zone being displayed at the station of the seller and the buyer; a communicator for sending at least one message to the buyer and the seller when a demand associated with a buyer and an offer associated with a seller match in the server.

### FIELD OF THE INVENTION

This invention relates to the field of electronic commerce and, more specifically, to a method and system for providing a marketplace to professionals.

### BACKGROUND

Many network-based commerce methods are known in the art. Widely deployed electronic marketplaces have been developed, for example by EBAY. In such a marketplace, the user wanting to buy a product has to search for it in a database. This can be done by using a search motor or a predefined list of items. When the registered user finds the item, the user can place a bid for the item, and the seller may accept it and make the transaction. The item is then traded online through the web site.

However, this kind of marketplace is not very efficient for professionals, who would like to negotiate the price and buy or sell an item, not only at the best price, but also with a particular and trusted client (buyer or seller) the professional wants to do business with.

Therefore, a need exists for such an electronic professional marketplace, where professionals can negotiate and trade as in a business conference room. This is because, in conventional electronic places using an auction system, when a client wants to buy a product, the client can not buy the product at the lowest price.

### SUMMARY OF THE INVENTION

One aspect of this invention includes a system for providing contact between a buyer and a seller, the system comprising:

a first zone in the form of a chat room, the first zone being displayed at the station of the seller and the buyer;

a second zone in the form of a data acquisition zone that provides a request associated with the selection of an action and a set of characteristics of a product, the second zone being displayed at the station of the seller and the buyer;

a first clickable zone for transforming the request in the data acquisition zone into at least one line in the first zone, the first clickable zone being displayed at the station of the seller and the buyer;

a second clickable zone such that, when the second clickable zone is activated, the request is sent to a server which has the ability to compare requests associated with offers and demands, the second clickable zone being displayed at the station of the seller and the buyer; and

a communicator that sends at least one message to the buyer and the seller when a demand associated with a buyer and an offer associated with a seller match in the server.

The system of the invention may also comprise a third zone to define a matching rate for the comparison of the requests associated with offers and demands, such that only offers and demands that match according to the matching rate cause the sending of a message to the seller and the buyer. This enhances matching between the orders.

Preferably, the system can also comprise a fourth zone for defining at least one priority level for the calculation of the matching rate.

The invention also concerns a method and an interface associated with the system. In particular, the method is a method for providing contact between a buyer and a seller, the method comprising:

displaying at the station of the buyer and the seller a first zone in the form of a chat room where messages can be displayed;

displaying a second zone in the form of a data acquisition zone for providing a request associated with the selection of an action and a set of characteristics of a product;

displaying a first clickable zone for transforming the request in the data acquisition zone into at least one line in the first zone;

displaying a second clickable zone such that, when the second clickable zone is activated, the request is sent to a server which has the ability to compare requests associated with demands and offers;

comparing requests associated with demands and offers at the server; and

sending at least one message to the buyer and the seller when a demand associated with the buyer and an offer associated with the seller match in the server.

The invention may be implemented as a computer program, either in an upload version in which the users need to install software on their computer (by downloading it from a web site, loading it from a disc or the like), in a web based version in which user can access the system on a web site and do not need to install any program on their computer or the like.

### BRIEF DESCRIPTION OF THE DRAWINGS

FIG. 1 illustrates an exemplary interface according to aspects of the invention.

FIGS. 2a and 2b illustrate an exemplary selection zone associated with the command function according to aspects of the invention.

FIG. 3 illustrates an exemplary selection zone associated with the autoresponse function according to aspects of the invention.

FIG. 4 illustrates an example of an order status window according to aspects of the invention.

FIG. 5 illustrates an example of a matching rate interface according to aspects of the invention.

### DETAILED DESCRIPTION

This invention provides a system in which offers and demands can be done in a tender mode, in which, when a buyer wants to buy a product, the buyer can buy the product at the lowest price, and in a bid mode, in which a seller can sell the product at the highest price.

Advantages of the invention can be seen in many aspects. For example, contrary to e-business web sites, the user of this invention does not need to search for a product for a long time. The user is directly notified of a match for the user's requests.

The system is, moreover, particularly useful for professionals who can be directly in contact without the presence of a third party, 24 hours a day and 7 days a week.

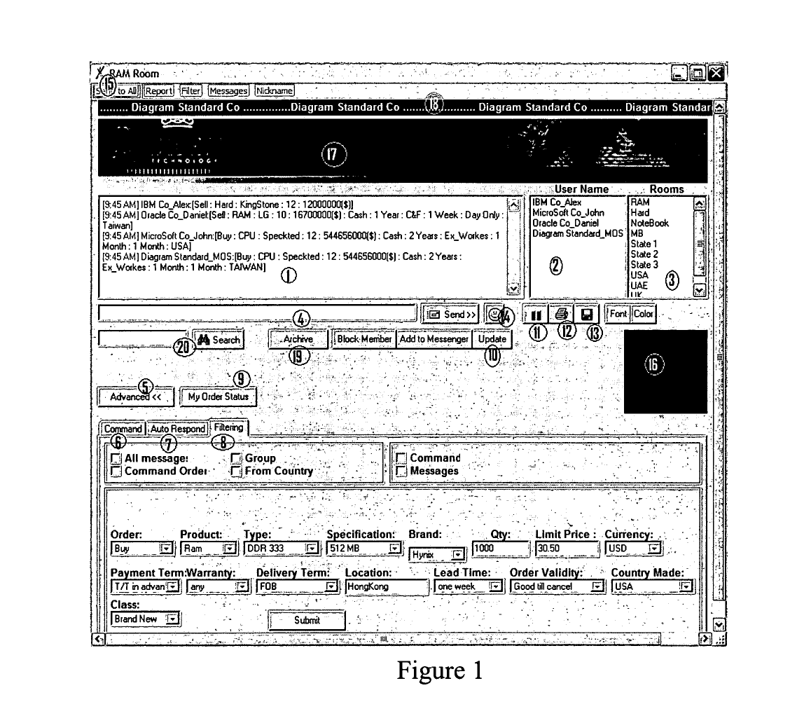

FIG. 1 depicts an exemplary interface displayed at a client station according to aspects of the invention. The interface comprises an active electronic conference room (1) known in the art. Registered clients can add a comment or professional offer or demand, for any product or item. The user clicks on a “send” icon and the message of the “message board” (4) is displayed in real time in the conference room to other online clients.

The user can also select a specific chat room from zone (3) of the interface. These specific chat rooms can be named by Item names, countries or states as shown in FIG. 1. This gives the opportunity to users to choose their favorite and proper area and business subjects and gives the opportunity to the administrator to select who can enter a specific chat room and who can not.

Comments or offers and demands and any message that a user can send on the chat room are generally referred to herein as “a message”.

As in a regular chat room, a user can click on a specific client's name to open a private chat room, for example, for private negotiations on a product.

The user can also use the “print function” (12) to print the content of the conference room, or the “save” function (13) to save it on a client station.

It is understood that the invention can be used as a regular chat room between registered professionals. However, according to another aspect of the invention, the software and the interface comprise advanced functions which can be accessed by clicking on the “advanced icon” (5).

When the advanced function is activated, at least 3 specific actions are displayed on the client station, with preferably a “command” function (6), an “autorespond” function (7) and a “filtering” function (8).

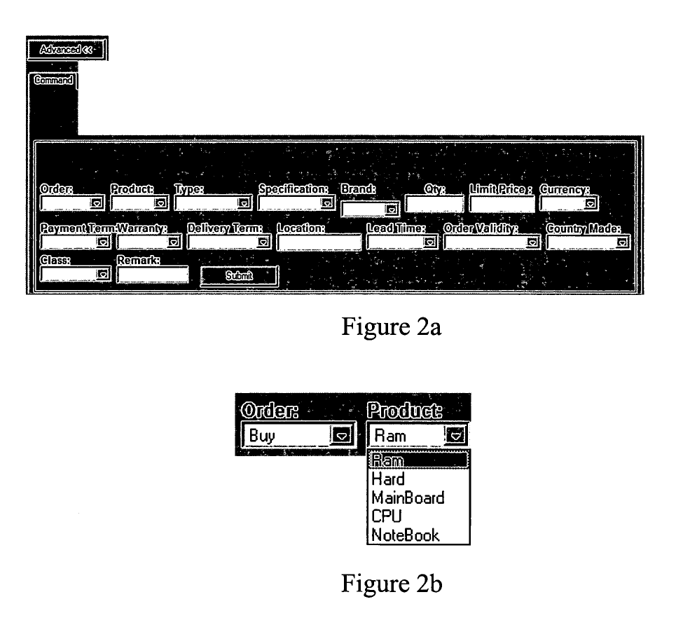

When the command function (6) is activated, the interface comprises a specific selection zone. This interface, the “selection interface” provides the user with the possibility to select any action, item, price, or other item stored in the administrator's database. Such a void selection zone is illustrated FIG. 2a. and the content of the selection zone is described in more detail below.

In one aspect, this kind of selection zone is useful to avoid mistakes in typing in the conference room or in the chat room and to display an offer or a demand that would not be understood by other users, especially for a professional usage.

When the user can select and send a specific action, for example “Buy”, for a specific quantity for example “1000” of a specific product, for example “RAM” as in FIG. 1, the content of the selection is displayed on the conference room as a message by using a “submit” icon. The selection step can be seen in FIG. 2b. This greatly facilitates retrieval of information for the other users of the chat room.

In one aspect, the interface comprises a first list L1 of the actions the user can make. For example, L1 comprises 2 actions “buy” and “sell”. The interface comprises a second list L2 of the product the user can select for an action. For example, L2 comprises “RAM”, “Laptop”, or the like.

The interface may comprise other lists that are related to L2, representing for example the specification of the product, its type, its brand, a limit price, a delivery time, a currency, the class of the item (second hand, new), or the like. The one skilled in the art can easily add a new list to facilitate the selection of the user.

If a user wants to make an action on a product or any item and/or characteristic that is not in the selection list, the item can be added by the administrator upon request of the user. In that case, the “update” function (10) can be used to display the new selection zone including any new item in the list.

The interface according to aspects of the invention may also comprise an advanced function in the form of an “autorespond” function (7). If this function is activated, the message of a user is stored in a server called the “administrator's server”, and a matching step is performed. The server compares the selected offer or demand with the other offer or demand of the conference room. If a match occurs, a notification is sent to the first user (U1) having put the offer or the demand with the autoresponse function, and the second user (U2) whose offer or demand matches with the first user's offer or demand.

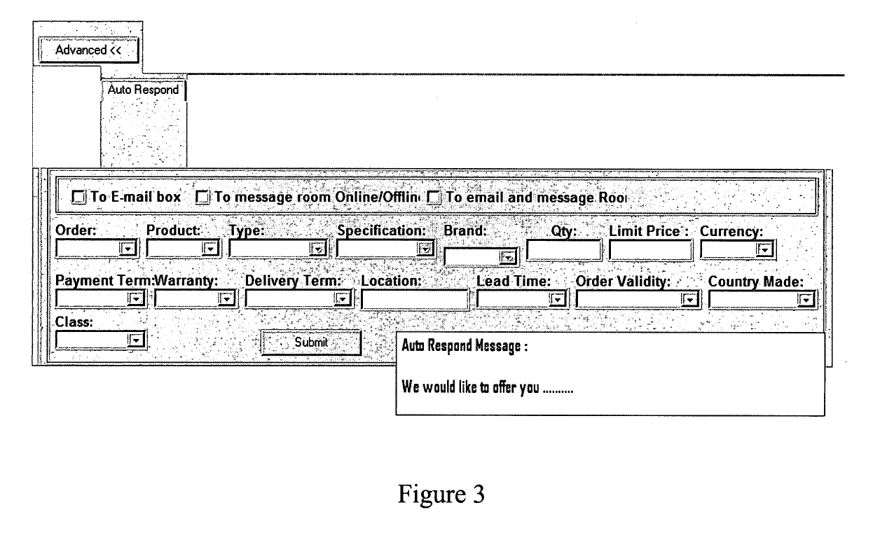

This notification is preferably sent by e-mail on the contact e-mail address of U1 and U2. The advantage of this notification is that it can be retrieved by U1 and/or U2, even if they are not online when the match occurs. The notification is preferably in the form of the message stored in the server for which the autoresponse function applies. Autorespond messages can also be sent via message (online message/off line message) or by e-mail and messages by choosing one of the choices illustrated in FIG. 3 in the autoresponse interface.

In another aspect, the automatic notification is achieved by using a message box where the messages representing a match by the autoresponse function are stored. The advantage of such a message box is to avoid accumulation of messages in the mail box of the user.

No automatic transaction is performed by the server, even if a match occurs, and U1 and U2 are totally free to trade the product or not. They can continue to negotiate the price or the quantity or the product.

For example, by using the autoresponse function, user 1 asks the server to send a message (“I sell 10 Nokia phones”) to whoever wants to buy the product being sold. In a particular embodiment, the user can specify if the user wants to match more than the product (for example, the price, the quantity, and the like). The message is sent even if the client is offline, by any communication means, or it is stored in a message box as defined above.

A time limit can be added to the autoresponse function, and the matching notification occurs only within this particular time limit. After this time limit, the message is removed from the server.

The autoresponse system may be limited to a certain number of messages for a client, for example, up to 10 messages.

In another aspect (not illustrated), the autoresponse and the command order function are combined in a unique “auto order” function. Thus, by using this specific function, users can put sell/buy orders by using the selection zone (in this case, the “auto order interface”). This first causes the display of the order on the conference room and forwards the order to an order's database. If any match occurs in the order's database, a message is forwarded to the seller and buyer, by e-mail, or an on-line/off-line message.

In the matching process, orders can be compared either with all valid orders including the orders that have been sent in the past, but still valid (not expired) and, also, future orders (incoming orders that will be sent after this moment by others), or only with future orders or only with valid orders.

In that aspect, the auto order interface also comprises a message box to select the various processes. For example, the following question can be asked to the user to help selection of the preferred process:

Do you want your order to be displayed on the conference room? YES/NO

Do you want your order to be compared (matching process) with the available valid orders stored in the Database? YES/NO

Do you want your order to be compared (matching process) with the coming future orders? YES/NO

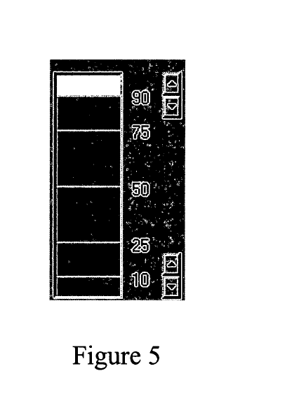

The system provides a matching rate interface to enhance the matching process, as illustrated FIG. 5. With this matching rate, the user only receives messages (corresponding to a matched order) that are in the specified matching rate's limitation. Accuracy of match results are controlled by percentage setting (between 1% and 100%) that every user can specify when placing the orders. It is thus understood that a higher percentage of matching rate will have a more accurate matching result.

The system comprises a priority setup interface to calculate the matching coefficient between orders (and then to see if the matching is within the specified limits of the user). With this priority interface, a specific element of the selection zone of the order interface can be more or less weighted in the calculation of the matching. The results displayed after a matching are in this case displayed according to the priority levels, for example, from 1 to 4, 1 being set for a not important characteristic of the selection.

The user can also select “key elements”. By selecting such “key element”, the ranking of these elements and the ranking of the other elements is done differently. For example, one can define that if the match is not perfect on the “key elements”, the matching notification must not be sent, even if the total ranking exceeds the user's predefined matching rate. Technically, these key elements are then matched prior to the other elements in the server database.

The system can provide a history of matched orders to report the activity of the matching server to the clients. This function shows, at a particular client's station, the list of the members along with their messages, whose orders have been matched with this particular client's order. The user can also view a list of the other members that have been notified of his order, in case of a match with the orders.

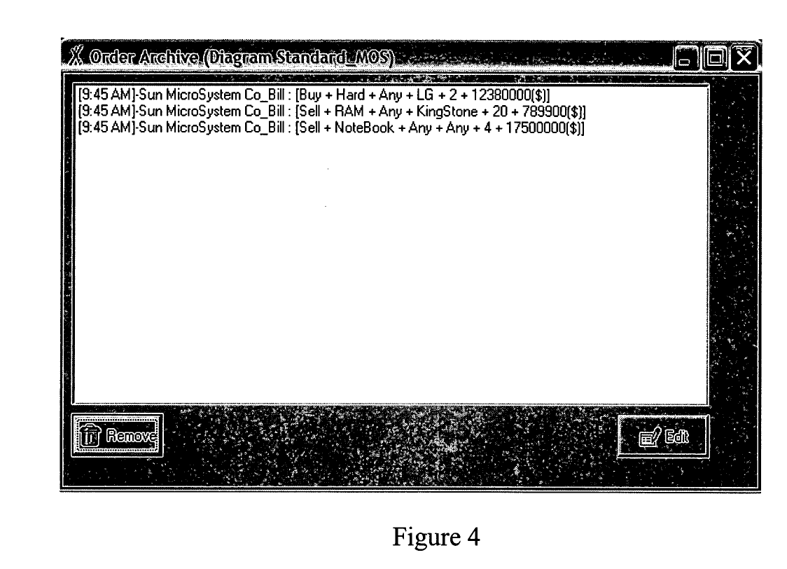

Moreover, the client who used the autoresponse function can access the server directly to modify the stored offer or the stored demand. More specifically, the “order status” function (9) allows the user to access active current orders available in the main server (the administrator's server). One example of this order status is shown FIG. 4. The user can also remove or edit orders by using this order status interface. This order status also includes the messages sent with the “command” function and not only with the autoresponse function.

The interface may also comprise an advanced function in the form of a “filtering” function (8). The filtering interface comprises the features that the user wants or does not want to be displayed on the user's station.

By using the “filtering function”, the user is able to see only information related to a product or a buyer or a seller. As illustrated in FIG. 1, the user can also select only messages from a specific country (for example, if the user doesn't want to ship abroad). It is understood that filtering can be either positive if a client wants to see only orders in which a specific word or expression appears, or negative, if the client does not want to see orders in which a specific word or expression appears.

The professional user is then much more efficient and is not disturbed by unwanted messages that the user is not interested in.

The interface and method of the invention can be very useful for professionals. Security and registration are important features. For that purpose, the administrator does not allow people to sign up directly for the service. They have to send a request to the administrator, who decides those who will be allowed in the conference room.

If a client is allowed, the administrator provides the client with a login and a password. The login is only associated with one particular client, for example, a company, DIAGRAM LLC, and it can not be changed. The password can be changed by the client.

The administrator chooses a nickname for the client, for example DIAGRAM, and the client may add a second part to this nickname, for example, DIAGRAM_Mustafa. Only this second part can be modified by the client.

The nickname of a client is associated with the profile of the company, and this profile can be retrieved by clicking on the nickname of the client. The “username” part of the interface is referenced as (2) in FIG. 1 and corresponds to the on line member list.

Additionally, a user can search for a particular nickname to find it in a specific chat room or to know whether the client associated with the nickname is online or not.

Moreover, access is allowed to several persons of the same company if they have a different second part of the nickname. For example, DIAGRAM_Mustafa can be on the RAM chat room while DIAGRAM_Kiana can be on the laptop chat room. These kinds of access authorizations can be given by the client company.

Any member can be searched with the search zone (20), if the user wants to verify a specific member who is online, or if the member is very interested in the offers of this specific member.

There is no need for the user to search for a particular item (as in the marketplaces that are known in the art), because the “autorespond” function will automatically notify the user that the product sought is available.

The invention can be used in a “tender mode” or in a “bid mode” thanks to the electronic conference room (1).

Pictograms (14) can be added in the chat room. These pictograms represent a particular emotion, for example, a smile for an interesting offer or a particular action or product. This pictogram can also represent the way a product can be shipped, for example, with a picture of a plane.

The interface may comprise a “pause icon” (11) activating a pause function to allow the user to view the offers and demands correctly on the chat room. The chat room remains still and no other message is displayed when the pause function is activated. The messages sent on the chat room during the pause are buffered in a local memory of the client station and can be retrieved by deactivating the pause function.

The system may further comprise several filters for the chat room. For example, some words can be filtered. Such words are stored in a database and are not displayed if they are part of a sent message. Repetition of the same offer or demand or message by the same user within a certain period of time can also be filtered for the clearness of the chat room.

All the messages from a client can also be blocked.

The system may further comprise an “archive” function (19). When this archive function is activated, the administrator's server keeps the proofs of a negotiation between the clients on a particular private chat room. It also allows the user to consult the offers and demands of third parties stored in the server database, or, with an advanced archive function, to consult the negotiations of the third parties.

The user can also contact other registered members by using the “send to all” function (15). In fact, as all registered members have to enter a valid e-mail address, this function can be used to send a message to all the members, even if the user has not been in contact with a specific member before. Such a function greatly improves relationships between professionals.

Finally, the interface may comprise a function (15) allowing the user to send a specific message or email to all or a group of members. It may also comprise a video screen (16) for displaying advertisements, a banner panel (17) and a text line (18) displaying the latest news in the market, prices, and the like.

The aspects described above are illustrative examples of the invention and it should not be construed that the invention is limited to these particular aspects shown and/or described. Various changes and modifications may be effected by one skilled in the art without departing from the spirit or scope of the invention as defined in the appended claims.

What is claimed is:

1. A system for providing contact between a buyer and a seller comprising:
a first zone in the form of a chat room displayed at a station of the seller and the buyer;
a second zone in the form of a data acquisition zone that provides a request associated with selection of an action and a set of characteristics of a product, the second zone being displayed at the station of the seller and the buyer;
a first clickable zone for transforming a request in the data acquisition zone into at least one line in the first zone, the first clickable zone being displayed at the station of the seller and the buyer;
a second clickable zone, wherein, when the second clickable zone is activated, the request is sent to a server which compares requests associated with offers and demands, the second clickable zone being displayed at the station of the seller and the buyer; and
a communicator that sends at least one message to the buyer and the seller when a demand associated with a buyer and an offer associated with a seller match in the server.

2. The system according to claim 1, further comprising a third zone that defines a matching rate for comparison of the requests associated with offers and demands, such that only offers and demands that match according to the matching rate cause a message to be sent to the seller and the buyer.

3. The system according to claim 2, further comprising a fourth zone that defines at least one priority level for calculating the matching rate.

4. A method for providing contact between a buyer and a seller comprising:
displaying at a station of the buyer and the seller a first zone in the form of a chat room where messages can be displayed;
displaying a second zone in the form of a data acquisition zone for providing a request associated with selection of an action and a set of characteristics of a product;
displaying a first clickable zone for transforming the request in the data acquisition zone into at least one line in the first zone;
displaying a second clickable zone, wherein, when the second clickable zone is activated, the request is sent to a server which compares requests associated with demands and offers;
comparing requests associated with demands and offers at the server; and
sending at least one message to the buyer and the seller when a demand associated with the buyer and an offer associated with said seller match in the server.

5. The method according to claim 4, further comprising defining a matching rate for comparison of the requests associated with demands and offers and, wherein, the sending is only realized for offers and demands whose comparison correspond to the matching rate.

6. The method according to claim 5, further comprising setting at least one priority level for calculating the matching rate.

7. An interface for providing contact between a buyer and a seller, the interface being displayed at the buyer's station and at the seller's station, the interface comprising:
a first zone in the form of a chat room where messages can be displayed;
a second zone in the form of a data acquisition zone for providing a request associated with selection of an action and a set of characteristics of a product;
a first clickable zone for transforming the request in the data acquisition zone into at least one message in the first zone; and
a second clickable zone, wherein, when the second clickable zone is activated, the request is sent to a server which compares requests associated with offers and demands.
